(19) United States
(12) Patent Application Publication
(10) Pub. No.: US 2009/0171681 A1
(43) Pub. Date: Jul. 2, 2009

(54) ENTERTAINER CARD SYSTEM AND METHOD

(75) Inventors: William Orban, Studio City, CA (US); Koko Polosjaian, Tarzana, CA (US)

Correspondence Address: FOLEY & LARDNER, 555 South Flower Street, SUITE 3500, LOS ANGELES, CA, 90071-2411, US

(73) Assignee: DogFly Entertainment, Inc.

(21) Appl. No.: 11/965,670

(22) Filed: Dec. 27, 2007

(51) Int. Cl. G06Q 99/00

(52) U.S. Cl. 705/1

(57) ABSTRACT

An entertainer fan service method comprises providing electronic access to a fan to a network service, and providing features associated with one or more entertainers on the network service, the entertainer being associated with a club. Providing electronic access may include providing an access code to the fan, the access code corresponding to one or more entertainers associated with the club. Providing electronic access may include providing an access card to the fan, the access card including a computer-readable medium having computer code to allow the fan to access the network service.

### BACKGROUND OF THE INVENTION

The present invention relates generally to the field of network services and, more particularly, to systems and methods relating to accessing or interacting with entertainers.

Nearly all entertainers, whether individuals or groups affiliated with clubs, teams or franchises, have fanatics (or fans) who support or follow the entertainer. Whether the entertainer is a professional athlete, an actor, a model or an adult entertainer, or affiliated with a professional team or an adult-oriented establishment, fans are generally limited to support or interaction with their favorite entertainer to conventional mechanisms. For example, for professional athletes, a fan may attend games or follow their favorite athlete through tracking their statistics. For adult entertainers, the fans are limited to attending adult establishments such as strip clubs to watch their favorite entertainer. Most fans desire additional mechanisms for interaction with or supporting their favorite entertainer.

### SUMMARY OF THE INVENTION

One aspect of the invention relates to an entertainer fan service method. The method comprises providing electronic access to a fan to a network service, and providing features associated with one or more entertainers on the network service, the entertainer being associated with a club. As used herein, “entertainer” may include an individual or group of individuals (such as band members). For example, “entertainer” may include an athlete, an actor, a model, an adult entertainer or other such individual. As used herein, a “club” may include an adult establishment, a team, a group, a franchise or other such organization. For example, a “club” may also include a record label or a movie studio.

In one embodiment, providing electronic access comprises providing an access code to the fan, the access code corresponding to the club or one or more entertainers associated with the club.

In another embodiment, providing electronic access comprises providing an access card to the fan, the access card including a computer-readable medium having computer code to allow the fan to access the network service.

In one embodiment, the access card is provided to the fan when the fan visits the club. The providing electronic access may further comprise providing an access code to the fan, the access code corresponding to one or more entertainers associated with the club.

In one embodiment, providing features comprises providing a photo stage including one or more photos of the entertainer in one or more categories.

In one embodiment, providing features comprises providing a video stage including one or more videos of the entertainer in one or more categories.

In one embodiment, providing features comprises providing one or more games featuring the entertainer and/or the club associated with the entertainer.

In another aspect of the invention, a computer-readable medium embodying a computer program configured to provide an entertainer fan service method comprises providing electronic access to a fan to a network service, and providing features associated with one or more entertainers on the network service, the entertainer being associated with a club.

### BRIEF DESCRIPTION OF THE DRAWINGS

FIG. 1 illustrates a block diagram of an entertainer card system according to an embodiment of the invention;

FIG. 2 illustrates an exemplary implementation of a process for the use of an entertainer card system;

FIG. 3 illustrates an exemplary entertainer card according to an embodiment of the present invention;

FIG. 4 illustrates a block diagram of the interaction between a user device with an entertainer card and a main server according to an embodiment of the invention;

FIG. 5 illustrates a screen shot of the home page of an entertainer card service according to an embodiment of the invention;

FIG. 6A illustrates a screen shot of the main stage of an entertainer in the entertainer card service according to an embodiment of the invention;

FIG. 6B illustrates a screen shot of the photo stage of an entertainer in the entertainer card service according to an embodiment of the invention;

FIG. 6C illustrates a screen shot of a print purchase page for an entertainer in the entertainer card service according to an embodiment of the invention;

FIG. 6D illustrates a screen shot of the video stage of an entertainer in the entertainer card service according to an embodiment of the invention;

FIG. 6E illustrates a screen shot of the VIP stage of an entertainer in the entertainer card service according to an embodiment of the invention;

FIG. 7A illustrates a screen shot of a memory game page in the entertainer card service according to an embodiment of the invention;

FIG. 7B illustrates a screen shot of a poker game page in the entertainer card service according to an embodiment of the invention;

FIG. 7C illustrates a screen shot of a slots game page in the entertainer card service according to an embodiment of the invention;

FIG. 7D illustrates a screen shot of a roulette game page in the entertainer card service according to an embodiment of the invention;

FIG. 8A illustrates a screen shot of a library page in the entertainer card service according to an embodiment of the invention;

FIG. 8B illustrates a screen shot of an “Entertainer of the Month” page in the entertainer card service according to an embodiment of the invention;

FIG. 8C illustrates a screen shot of a “Collector's Edition” page in the entertainer card service according to an embodiment of the invention;

FIG. 9A illustrates a screen shot of a guestbook page in the entertainer card service according to an embodiment of the invention;

FIG. 9B illustrates a screen shot of the downloads page in the entertainer card service according to an embodiment of the invention;

FIG. 10 illustrates a screen shot of a merchandise page in the entertainer card service according to an embodiment of the invention;

FIG. 11A illustrates a screen shot of a club commercial page in the entertainer card service according to an embodiment of the invention;

FIG. 11B illustrates a screen shot of a sponsor commercial page in the entertainer card service according to an embodiment of the invention;

FIG. 12A illustrates a screen shot of a page from a mobile edition of the entertainer card service according to an embodiment of the invention;

FIG. 12B illustrates a screen shot of a calendar page in the entertainer card service according to an embodiment of the invention; and

FIGS. 13A-E illustrates a screen shots of pages for the back end of the entertainer card service according to an embodiment of the invention.

### DETAILED DESCRIPTION OF THE PREFERRED EMBODIMENTS

Embodiments of the present invention provide innovative mechanisms for offering fans additional access or interaction with various entertainers.

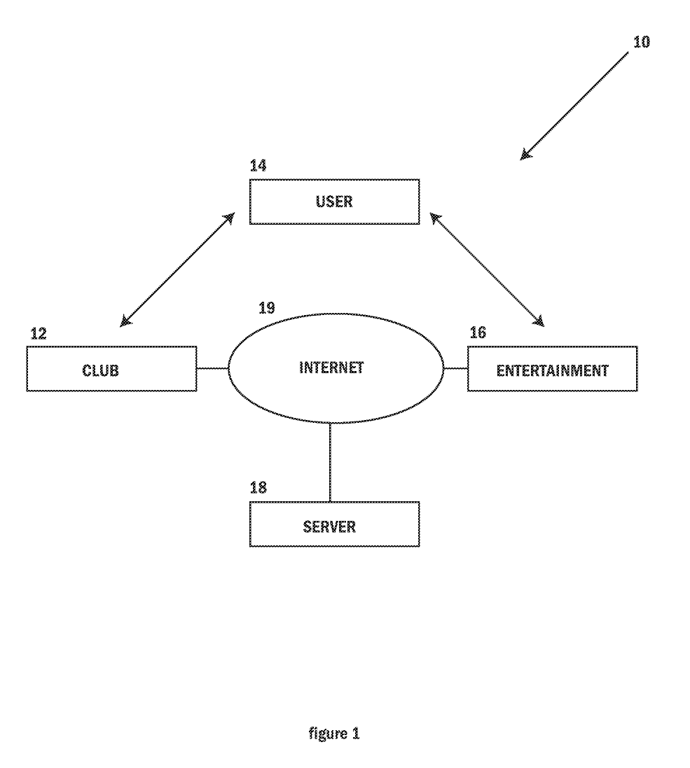

Referring now to FIG. 1, a block diagram of an entertainer card system according to an embodiment of the invention is illustrated. The entertainer card system 10 allows communication between a user 14, such as a fan, and an entertainer 16. The entertainer may be affiliated with a club 12. As used herein, “entertainer” may include an individual or group of individuals (such as band members). For example, “entertainer” may include an athlete, an actor, a model, an adult entertainer or other such individual. As used herein, a “club” may include an adult establishment, a team, a group, a franchise or other such organization. For example, a “club” may also include a record label or a movie studio. In the case of athletes, the club 12 may be a team, league, players union or other such organization. In the case in which the entertainer 16 is a model, actor or other celebrity, the club 12 may be a magazine, union, guild or other such organization. If the entertainer 16 is an adult entertainer, such as an exotic dancer, the club 12 may be an adult establishment, a union or another organization. In one preferred embodiment, the entertainer 16 is an exotic dancer, and the club 12 is an adult establishment, such as a strip club.

Each of the club 12, user 14 and the entertainer 16 connects to the system 10 through a communication device, such as a personal computer, a desktop computer, a laptop computer, a personal digital assistant (PDA) or any other such communication device. Such communication devices are able to communicate with a main server 18 and engage in a client-server relationship with the main server 18. The communication with the main server 18 is preferably through a communication network 19. In one preferred embodiment, the communication network 19 is a public network such as the Internet.

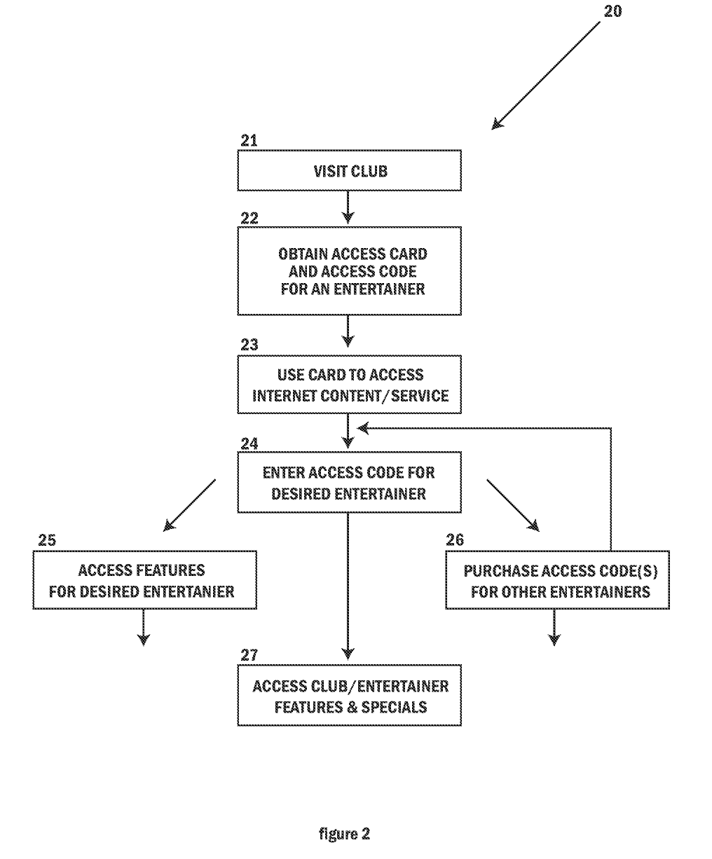

Referring now to FIG. 2, an exemplary implementation of a process for the use of an entertainer card system according to an embodiment of the present invention is illustrated. The process 20 begins when a user 14 visits a club 12 (block 21). As noted above, the user 14 is preferably an individual visiting an adult establishment, such as a strip club.

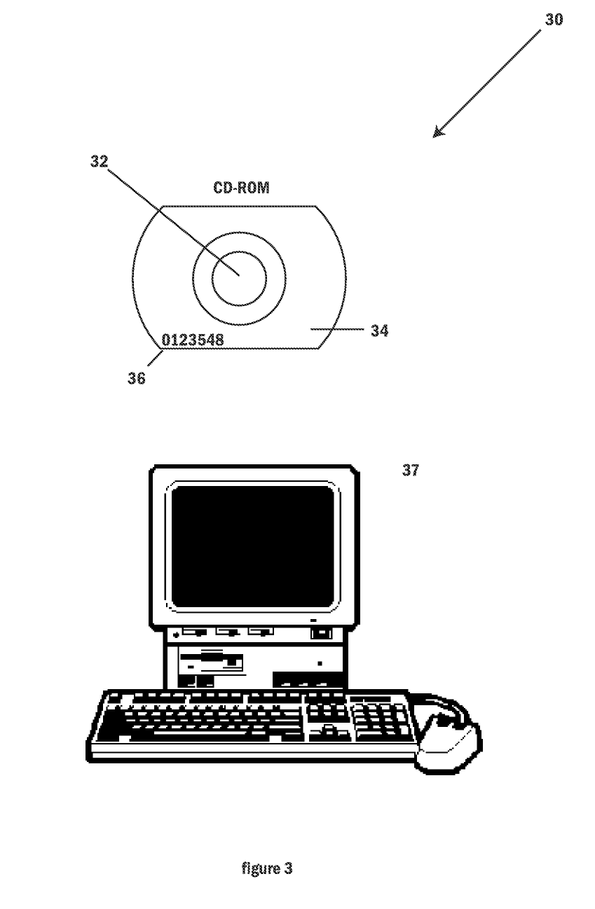

During the visit to the club 12, the user may obtain an access card and an access code (block 22). An embodiment of an access card according to an embodiment of the invention is illustrated in FIG. 3. In the embodiment illustrated in FIG. 3, the access card 30 is a computer-readable storage medium, such as a compact disk (CD). The CD may be cut or formed in the shape of a business card. The access card 30 includes a central opening 32 adapted to engage a spindle of a CD drive of a computer 37, for example. Further, the access card 30 includes a data portion 34 which may store a variety of types of data, including text and graphics, for example. In a preferred embodiment, the data portion 34 includes an executable software program, as described below in greater detail. The access card 30 of FIG. 3 further includes an access code 36 written on the surface of the access card 30. Alternatively, the access code 36 may be printed on a label placed on the access card 30 or a packaging of the access card 30, for example.

The access card 30 and the access code 36 may correspond to a specific entertainer. In this regard, each entertainer in the club may seek to provide her access card 30 to as many club patrons, or users, as possible. In one embodiment, the entertainers sell the access card 30 with the access code 36 for a fixed amount. In another embodiment, the access card 30 may be provided by the club 12, while the access code 36 is provided separately by the entertainer. In this embodiment, the club 12 may either sell or give away the access cards.

The user may then use the card to gain access to the access card service using the access card system described above with reference to FIG. 1 (block 23). In this regard, after leaving the club 12, the user may insert the access card 30 into the CD drive of a communication device. As described above, the access card 30 includes a data portion 34 which may include computer-readable program code. In this regard, the code may instruct the communication device of the user to connect to the main server 18 through the Internet.

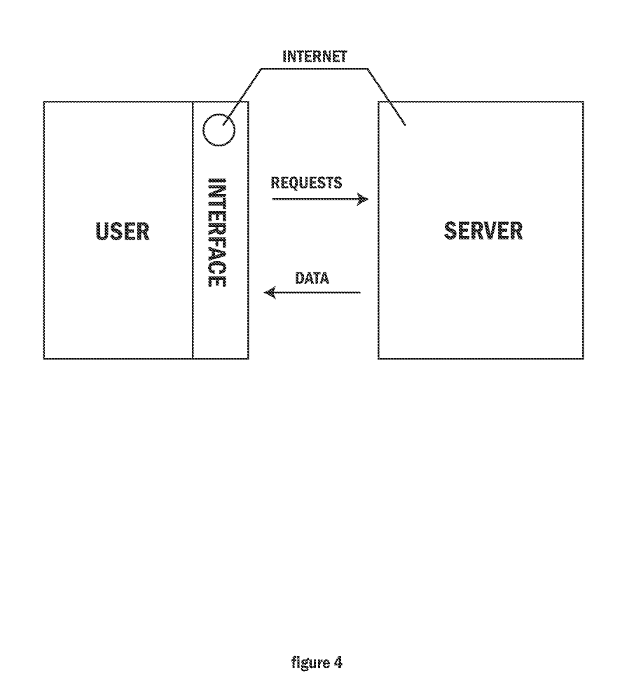

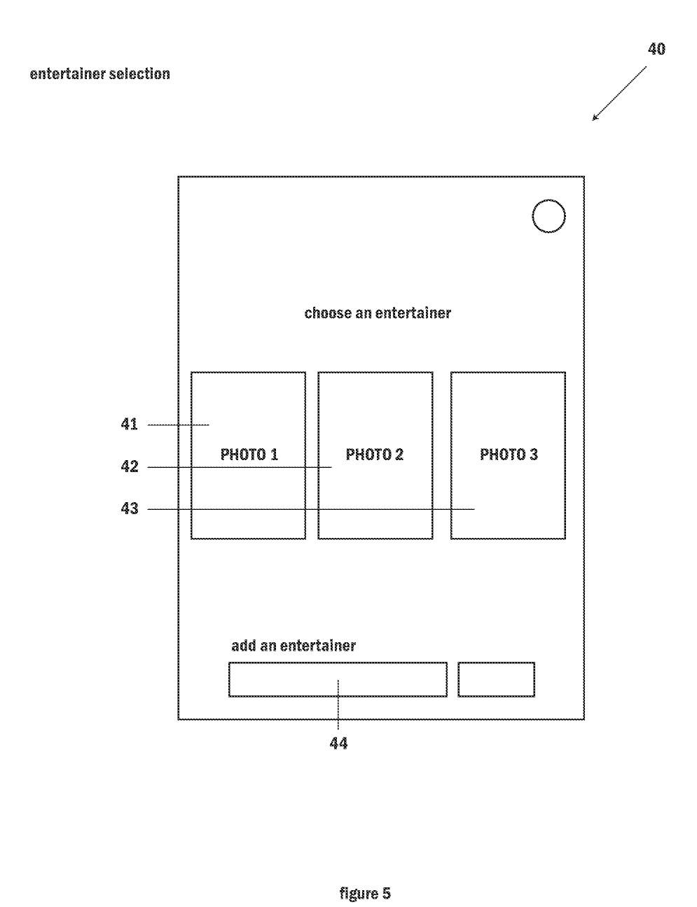

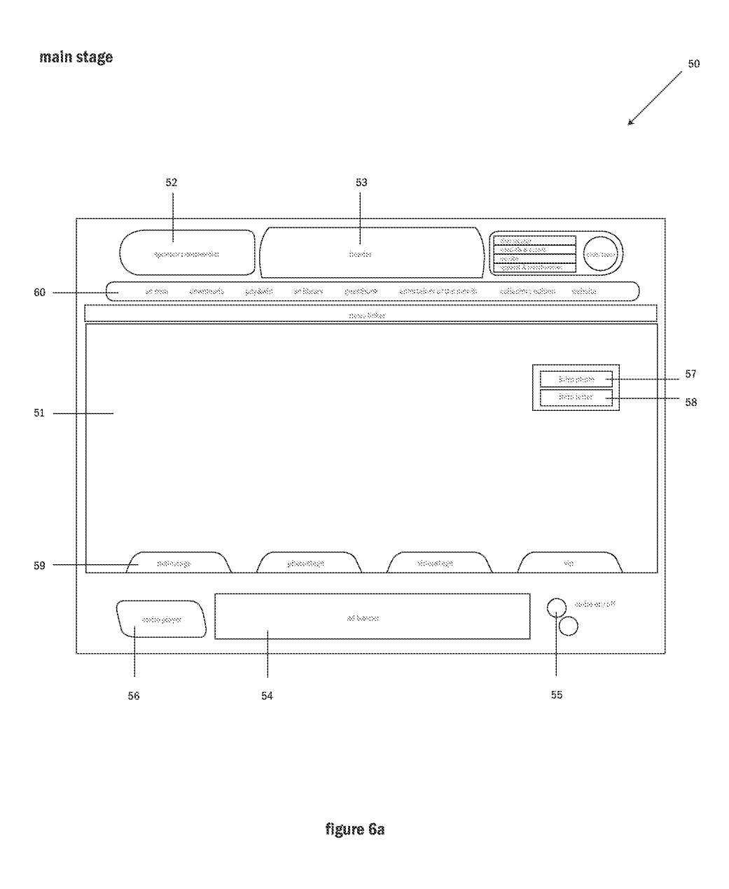

Further, the access card 30 may include an interface and templates for presentation of the service and various data to be presented to the user, as described below with reference to FIGS. 5-12. In this regard, FIG. 4 illustrates a block diagram of the interaction between the user's communication device with the access card 30 and the main server according to an embodiment of the invention. The code on the access card 30 provides an interface by which the user's communication device requests data from the main server, and the main server delivers the data through the Internet. Since only data is required to be transferred, the necessary information can be presented to the user at a faster speed.

Once the connection has been established, the user may be presented with a home page of the entertainer card service. FIG. 5 illustrates a screen shot of an exemplary home page 40 of the entertainer card service according to an embodiment of the invention. The home page 40 may includes pictures 41-43 of one or more entertainers for which the user has already paid and registered. For a new user, no pictures may be displayed. Alternatively, for a new user, one or more advertisements may be presented in place of the pictures of entertainers. The home page 40 includes a block 44 for entry of the access code of a new or additional entertainer.

Referring again to FIG. 2, the user may enter the access code for the entertainer from whom the access card and/or the access code was purchased or a previously purchased access code for another entertainer. The access code may be entered into the block 44 on the home page 40 of the entertainer card service. Entry of the access code allows the user access to various features of the entertainer card service. For example, the user may obtain access to features of one or more entertainers (block 25) or to various features provided by the club (block 27).

Additionally, the user may be provided with the option of purchasing access codes of other entertainers (block 26). The other entertainers may be entertainers at the same club or may be affiliated otherwise with the club. Once the purchase codes for additional entertainers are purchased, the user may return to block 24 to obtain access to the features of the newly added entertainers.

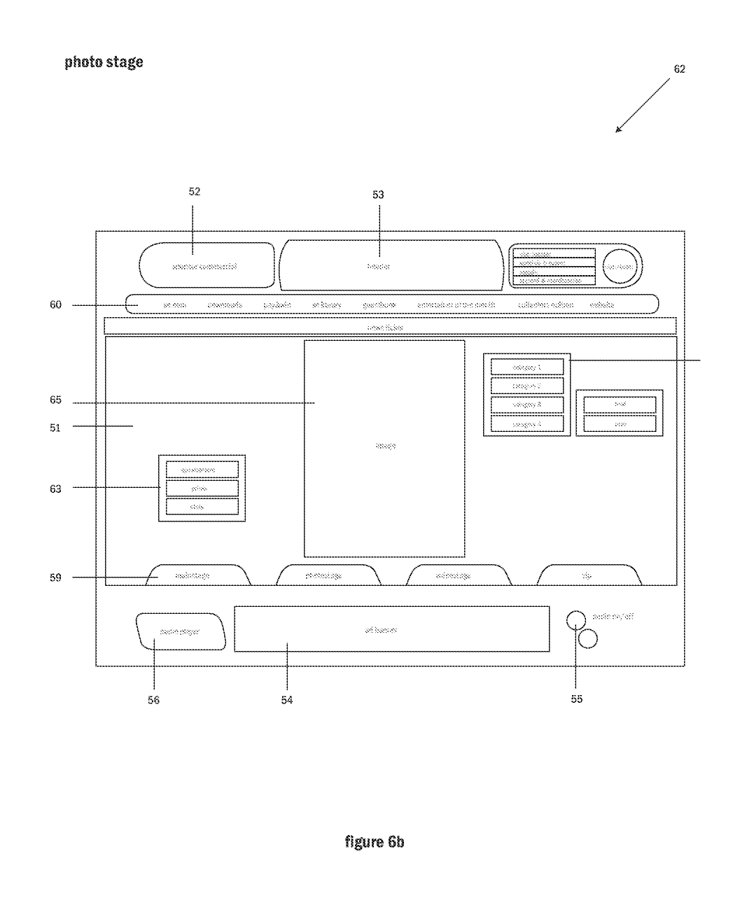

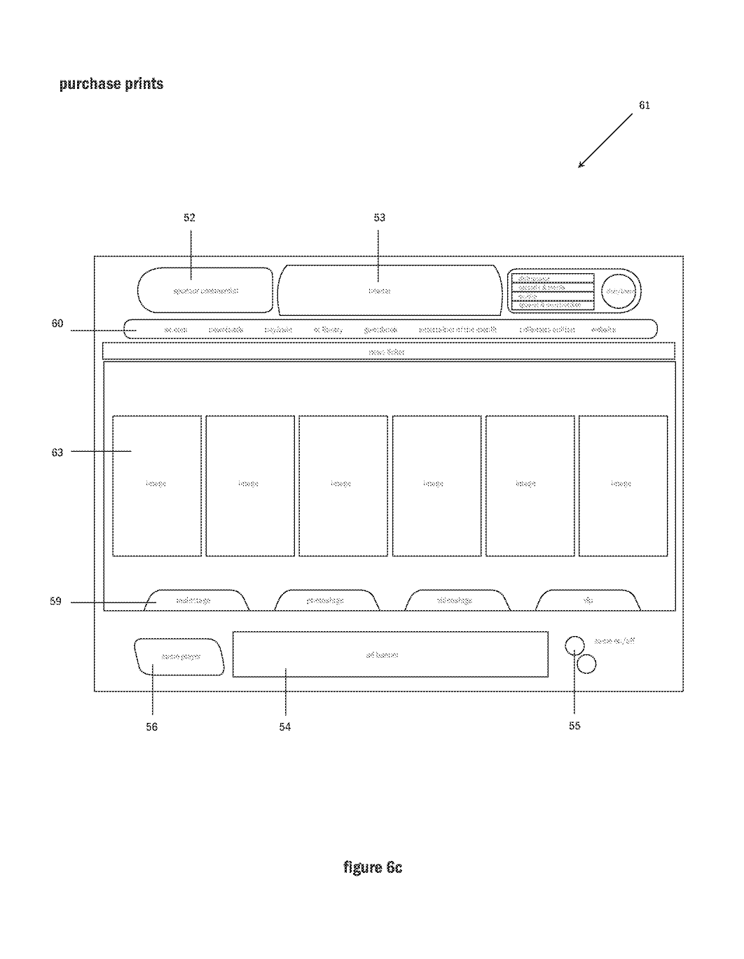

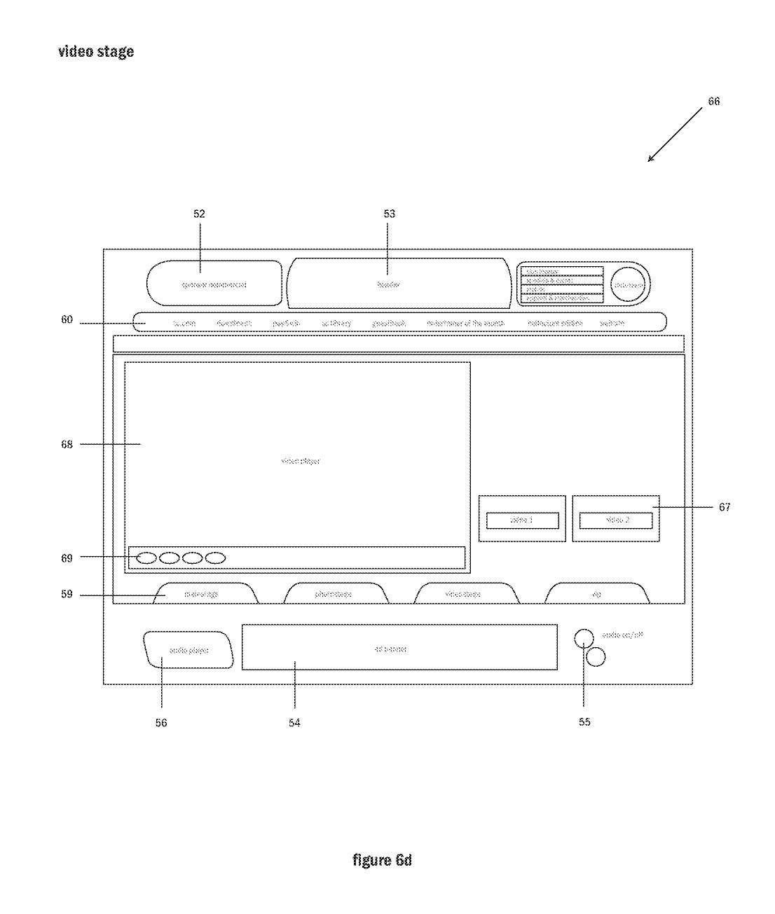

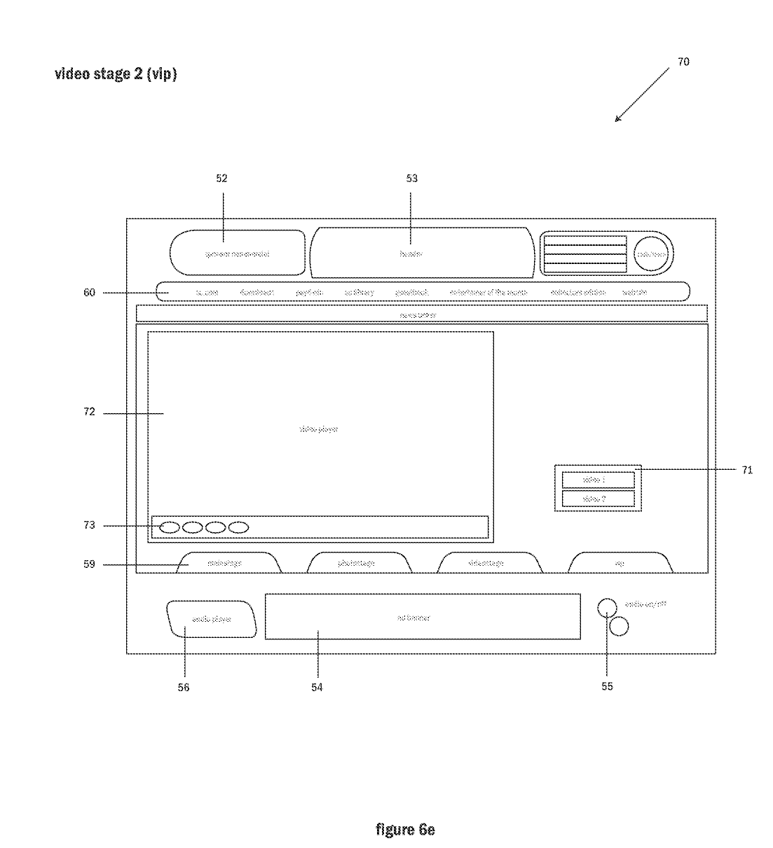

The features accessible by the user are described below in greater detail with reference to FIGS. 6A-12.

Upon entry of the access code for a particular entertainer, the user may be presented with the main page (or main stage) of that entertainer. FIG. 6A illustrates a screen shot of the main stage of an entertainer in the entertainer card service according to an embodiment of the invention. As described above, the template for the displayed page may be stored on the access card, while the data to be included in the page (such as data specific to the entertainer) may be transmitted from the main server.

The main stage 50 of the entertainer features a photo 51 of the entertainer in the background. The photo is surrounded by many of the features which may be included in the template. For example, a logo for the service provider 52 of the entertainer card service and a logo from the club 53 may be provided on a banner on the top of the page. Additionally, an advertising banner 54 near the bottom of the page may be provided.

Presentation of the main stage 50 may be accompanied by background audio selections, such as music selections. The audio selections may be provided either on the access card or through the main server. The user may be provided with the ability to control the audio selection using audio controls 55, 56. The audio controls 56 may be displayed when the user positions the cursor in the region of the audio controls 56.

Various tabs 59 may be provided for selection of additional features of the entertainer, while additional entertainer features and club features may accessed through the menu selections 60 displayed near the top of the page. Other selections may be superimposed on the background photo 51 of the entertainer. In the embodiment illustrated in FIG. 6A, an “Open Picture” tab 57 and an “Open Note” tab 58. When the user clicks on the “Open Picture” tab 57, a photo selected by the entertainer may be displayed. Similarly, when the user clicks on the “Open Note” tab 58, a personal message from the entertainer is displayed.

The entertainer tabs 59 may be used to display various other features related to the entertainer. Exemplary features are described below with reference to FIGS. 6B-6E. The entertainer tabs may be selected to display a photo stage 50 (FIG. 6B), a print purchase page (FIG. 6C), a video stage (FIG. 6D) or a VIP stage (FIG. 6E).

FIG. 6B illustrates a screen shot of the photo stage 62 of an entertainer in the entertainer card service according to an embodiment of the invention. As noted above, many of the items displayed on the various pages are part of the template and may not change from the previous page. Some such items are labeled in the figures with the same reference numerals.

The photo stage 62 may allow a user to view the entertainer in different poses or in different outfits, for example. Accordingly, the photo stage includes photo selections 64 corresponding to various photo categories and pictures within each category. Pictures from the selected category are displayed on a photo window 65 in the photo stage 62. Additional entertainer features 63 are made accessible to the user on the photo stage 62. For example, a questionnaire filled in by the entertainer may be accessed to learn the likes, dislikes and/or biographical information of the entertainer. Further, a “Purchase Prints” button may be provided to allow the user to purchase hardcopy or electronic pictures of the entertainer and may direct the user to the print purchase page described below with reference to FIG. 6C.

FIG. 6C illustrates a screen shot of the print purchase page 61 for an entertainer in the entertainer card service according to an embodiment of the invention. The print purchase page 61 may offer the user a selection of pictures 63 for which a print may be purchased. Each picture 63 is provided with a “PURCHASE PRINT” button to allow the user to select the print for purchasing. Pressing the “PURCHASE PRINT” button may add the print to the user's cart or may direct the user to a payment page.

FIG. 6D illustrates a screen shot of the video stage 66 of an entertainer in the entertainer card service according to an embodiment of the invention. The video stage 66 allows a user to view videos of the entertainer provided by the entertainer, the club or the service provider. In this regard, the video stage 66 includes video selections 67 corresponding to various videos. Each video may be provided in various resolutions depending upon the user's desires and capabilities of the user's communication device. Selection of a video causes the video to be displayed on a video window 68 on the video stage 66. The user may be provided with video controls 69 to control the display of the video.

FIG. 6E illustrates a screen shot of the VIP stage 70 of an entertainer in the entertainer card service according to an embodiment of the invention. The VIP stage may include special features associated with the entertainer, including special videos, for example. As with the video stage described above, the user may be provided with various selections 71 to choose from, including the ability to choose a different resolution of the video. Selection of a video causes the video to be displayed on a video window 72 on the VIP stage 70. The user may be provided with video controls 73 to control the display of the video.

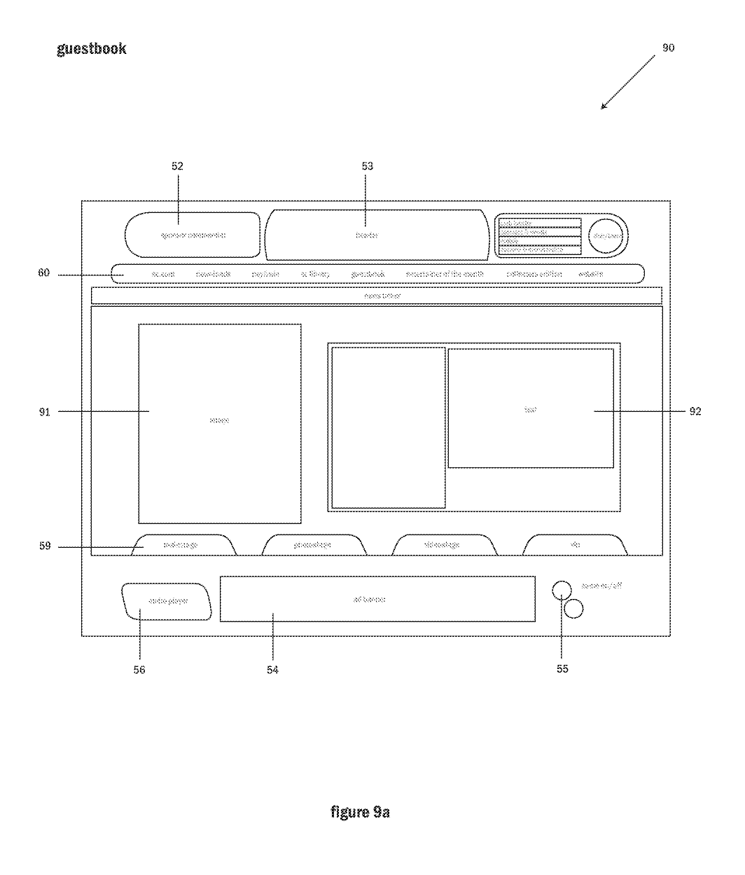

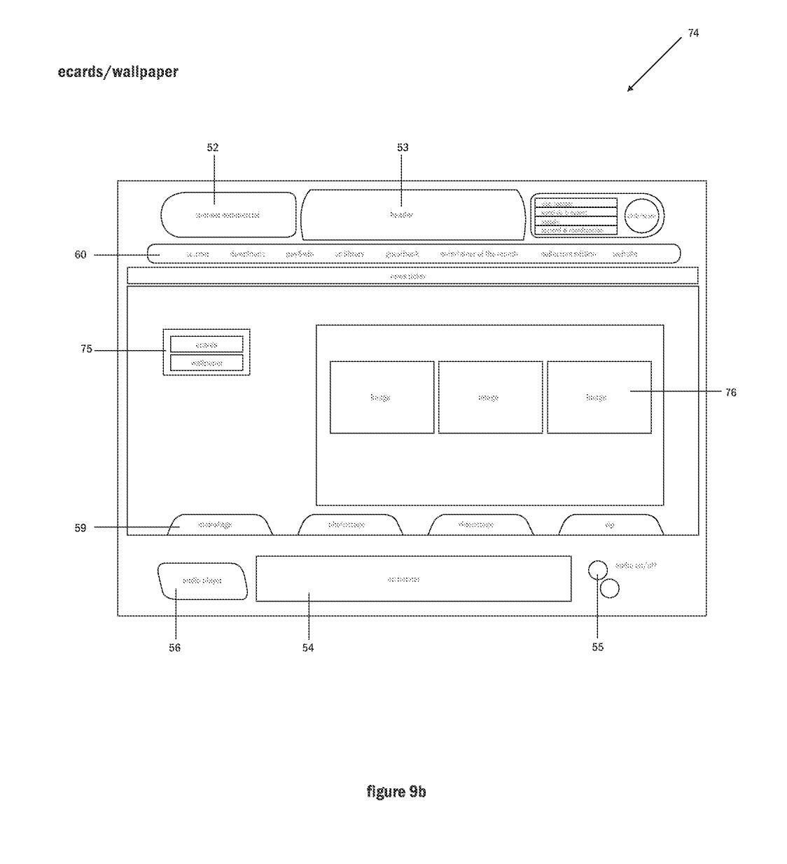

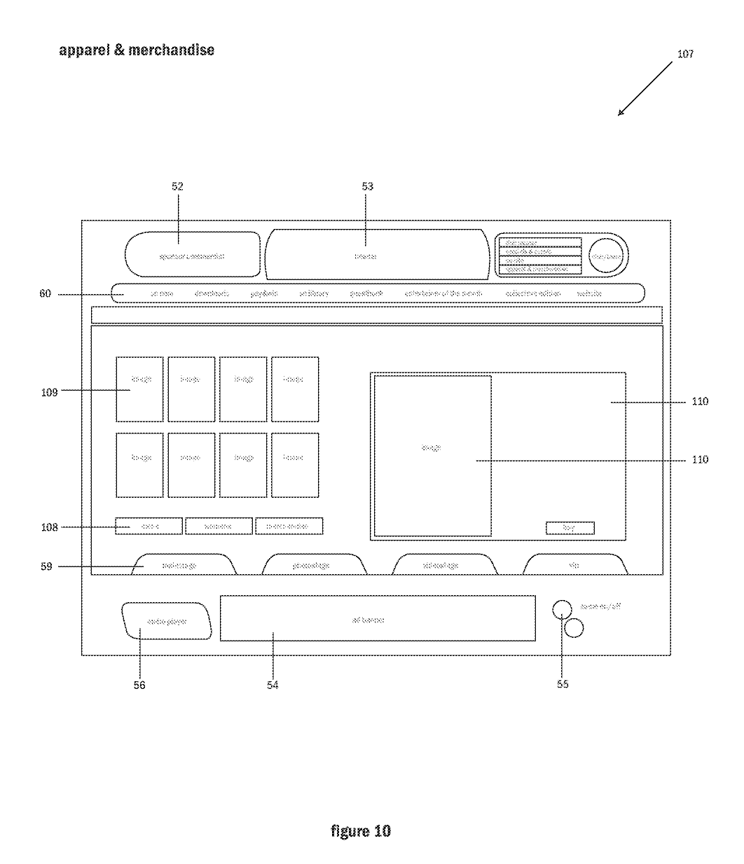

As noted above, additional entertainer features may be accessed through the menu selections 60 illustrated in FIG. 5. FIG. 9A illustrates one such feature. A screen shot of an entertainer guestbook page 90 in the entertainer card service according to an embodiment of the invention is illustrated in FIG. 9A. The entertainer guestbook page 90 allows a user to leave messages for the entertainer. In this regard, a message window 92 is provided in which the user may enter his message to be posted for the entertainer. The message may then be emailed to the entertainer by the service provider, for example. The entertainer guestbook page 90 may also include a photo 91 of the entertainer.

As noted above, various club features may be made accessible by the user. For example, FIG. 9B illustrates a screen shot of a downloads page 74 in the entertainer card service according to an embodiment of the invention. The downloads page 74 allows a user to download certain elements associated with the club and/or the entertainer. In this regard, the downloads page 74 includes a downloads selection area 75. For example, the user may select from one or more wallpapers 76 to be downloaded for use as wallpaper on the user's computer monitor.

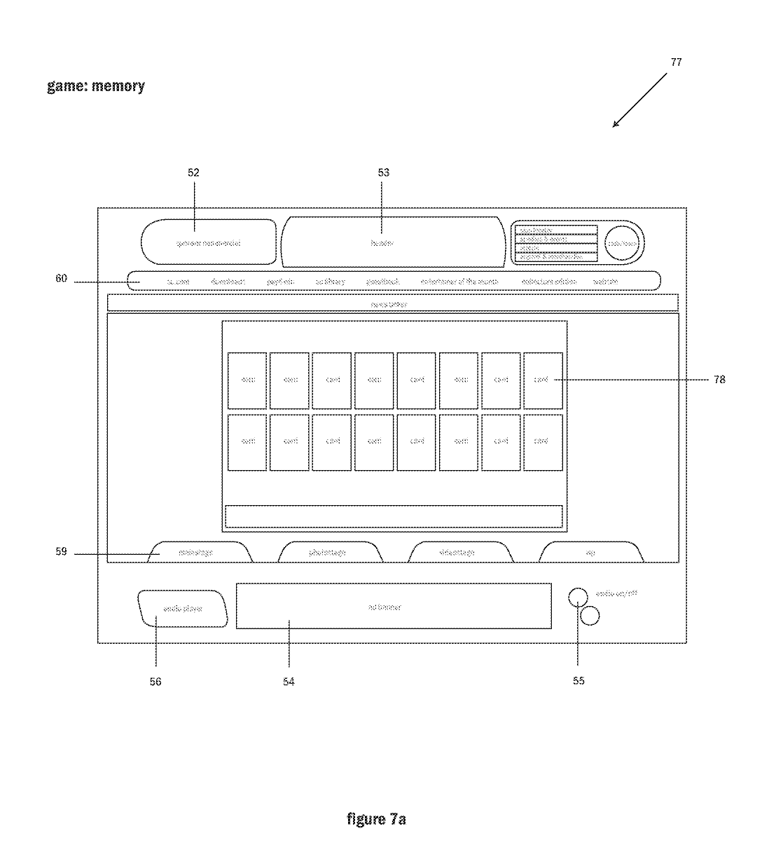

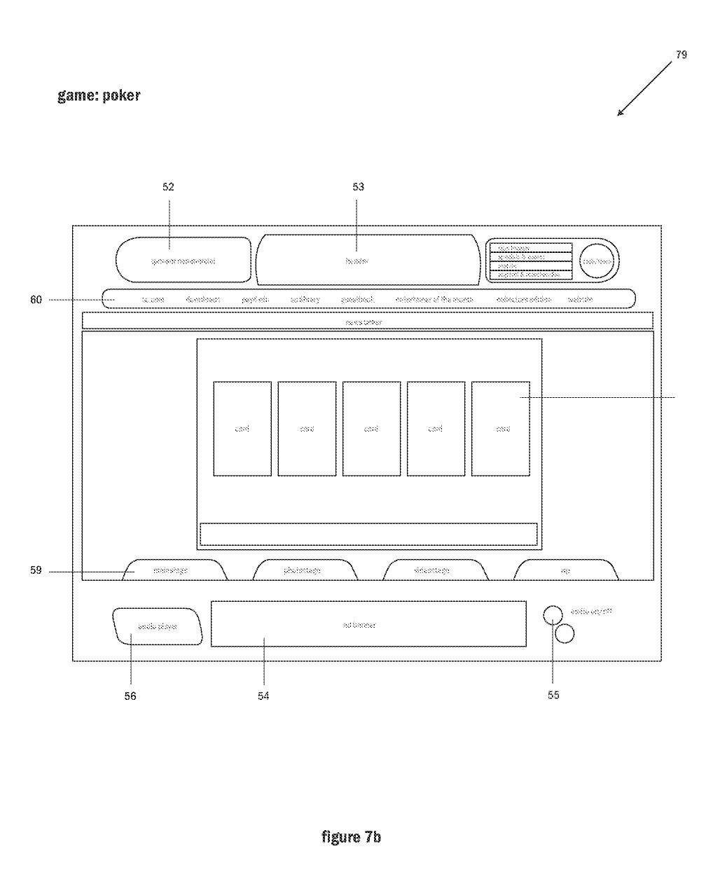

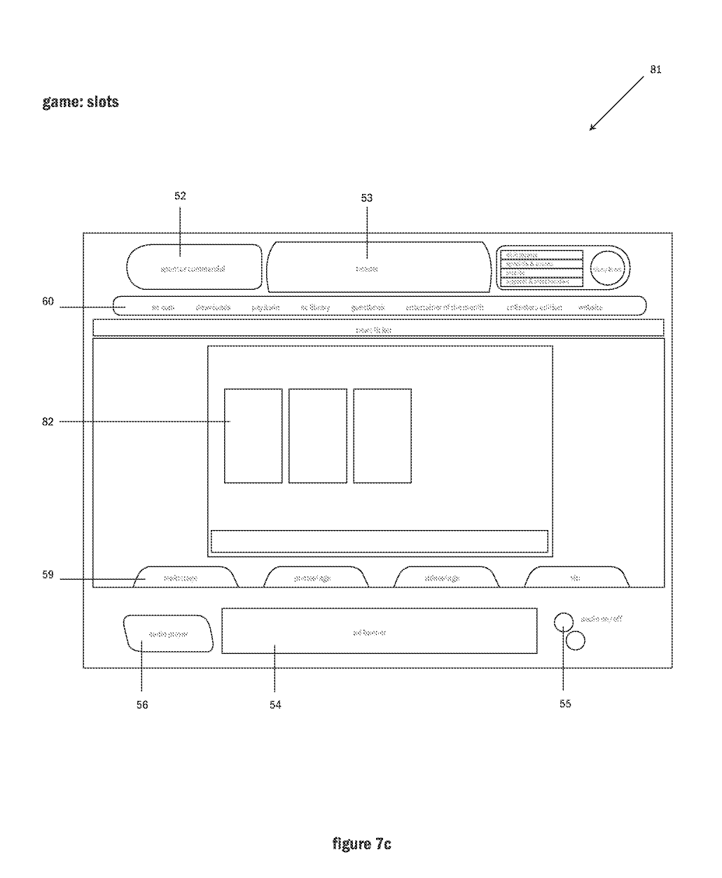

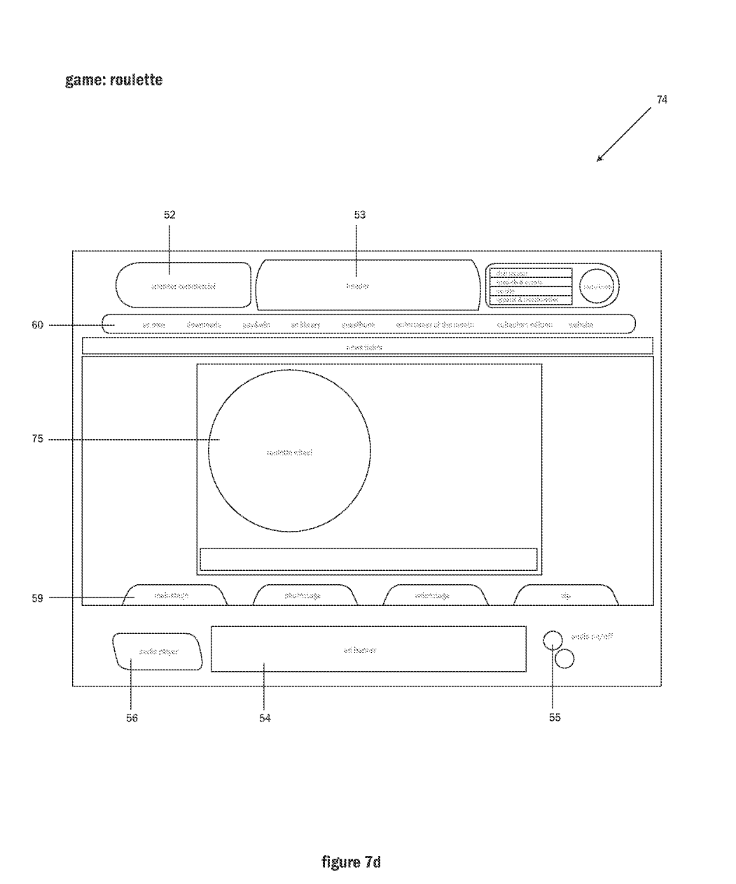

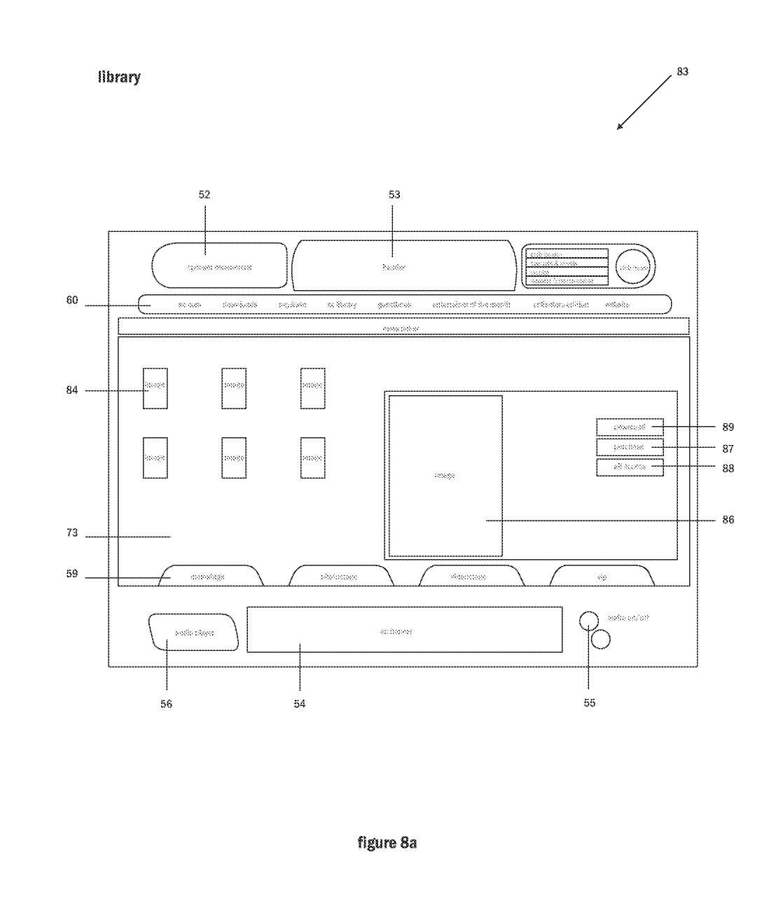

As a feature related to the club and the entertainer, the user may be provided with one or more games. FIGS. 7A-7D illustrate exemplary games which may be provided. The specific games may vary based on the specific field of the entertainer. In one embodiment, the user may collect points by playing the game. The points, or winnings, may be used as incentives for the user to either visit the club, purchase merchandise from the website or to purchase products or services from advertisers, for example.

FIG. 7A illustrates a screen shot of a memory game page 77 in the entertainer card service according to an embodiment of the invention. The memory game page 77 may display a number of match cards 78 showing the logo of the club. The user may click on a card to turn it over. The turned over card features a picture of the entertainer in one of a plurality of outfits and/or poses. The object of the game is for the user to select two cards with matching pictures. If non-matching cards are selected, the cards are turned back over to display the club logo.

FIG. 7B illustrates a screen shot of a poker game page 79 in the entertainer card service according to an embodiment of the invention. The game provided on the poker page 79 is similar to video poker games well known to those skilled in the art. One side of the cards features the club logo, while the other side may feature pictures of the entertainer in various poses.

FIG. 7C illustrates a screen shot of a slots game page 81 in the entertainer card service according to an embodiment of the invention. The slots game page 81 features a video slot machine similar to video slot machines well known to those skilled in the art. The video slot machine includes slot windows 82 which may feature conventional symbols, such as cherries, or pictures of the entertainer in various outfits and/or poses.

FIG. 7D illustrates a screen shot of a roulette game page 74 in the entertainer card service according to an embodiment of the invention. The roulette game page 74 features a roulette table with a video roulette wheel 75. The video roulette wheel includes numbers and colors similar to conventional roulette wheels, and the roulette table includes a betting region similar to conventional roulette tables.

The user may be provided an opportunity to win prizes by playing these games. The prizes may include free entry to the club or free drinks at the club.

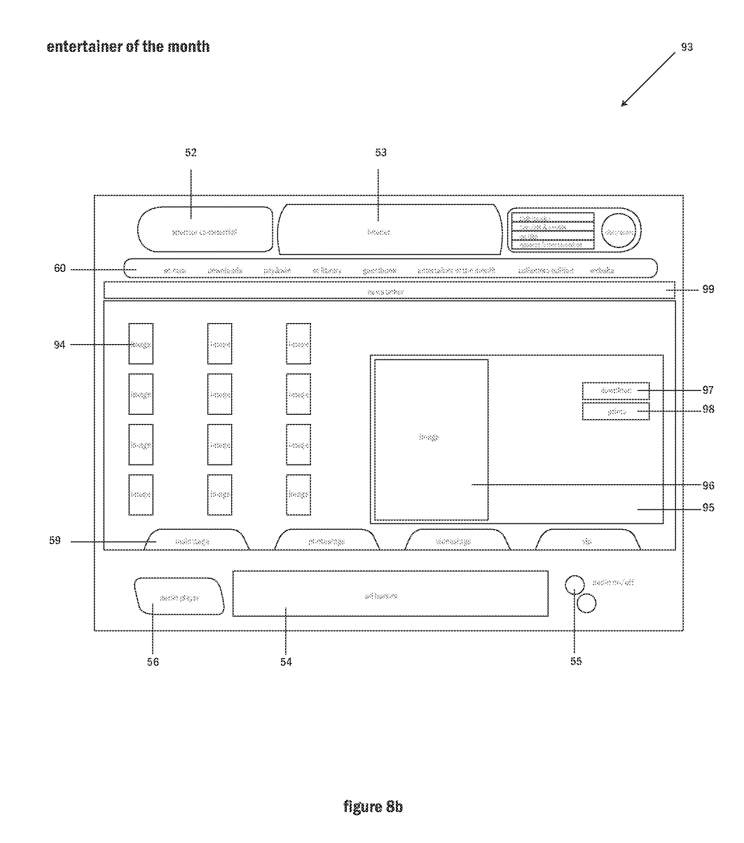

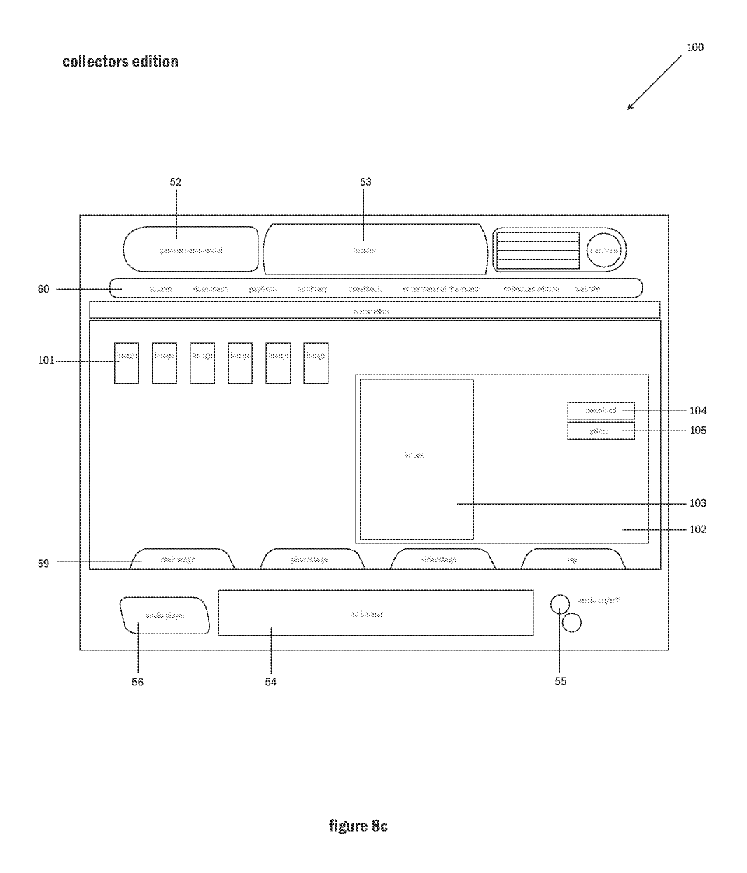

FIG. 8A illustrates a screen shot of a library page 83 in the entertainer card service according to an embodiment of the invention. The library page 83 may include thumbnail pictures 84 of other entertainers either at the club or otherwise affiliated with the club. The user may select an entertainer by clicking on the appropriate thumbnail picture 84. Upon selection of a thumbnail, an entertainer window 85 is populated with information relating to the selected entertainer. For example, a larger photo 86 of the entertainer may be displayed. The larger photo 86 may be the same picture as that in the thumbnail or may be different. In addition to the larger photo 86, the entertainer window 85 may include a button 87 which allows the user to download an access code for that entertainer. An additional button 88 may allow the user to purchase prints of the entertainer. As noted above, the purchased prints may be hardcopy or electronic prints. The entertainer window 85 may also include various statistics 89 related to the entertainer.

FIG. 8B illustrates a screen shot of an “Entertainer of the Month” page 93 in the entertainer card service according to an embodiment of the invention. The “Entertainer of the Month” page 93 may include thumbnail pictures 94 of each entertainer selected as an “Entertainer of the Month” for the past several months. The user may select an entertainer by clicking on the appropriate thumbnail picture 94. Upon selection of a thumbnail, an entertainer window 95 is populated with information relating to the selected entertainer. For example, a larger photo 96 of the entertainer may be displayed. The entertainer window 95 may also include a button 97 which allows the user to download an access code for that entertainer. An additional button 98 may allow the user to purchase prints of the entertainer. As noted above, the purchased prints may be hardcopy or electronic prints. The entertainer window 95 may also include various statistics 99 related to the entertainer.

FIG. 8C illustrates a screen shot of a “Collector's Edition” page 100 in the entertainer card service according to an embodiment of the invention. The “Collector's Edition” page 100 may include thumbnail pictures 101 of special entertainers, such as celebrity entertainers or visiting entertainers. As with the library page 83 (FIG. 8A) and the “Entertainer of the Month” page 93 (FIG. 8B), on the “Collector's Edition” page 100, the user may select an entertainer by clicking on the appropriate thumbnail picture 101. Upon selection of a thumbnail, an entertainer window 102 is populated with information relating to the selected entertainer. For example, a larger photo 103 of the entertainer may be displayed. The entertainer window 102 may also include a button 104 which allows the user to download an access code for that entertainer. An additional button 105 may allow the user to purchase prints of the entertainer. As noted above, the purchased prints may be hardcopy or electronic prints. The entertainer window 102 may also include various statistics 106 related to the entertainer.

In one embodiment, the entertainer card service may provide the user with a mechanism for purchasing merchandise related to the entertainer, the club, the service provider or 3^{rd} party advertiser. FIG. 10 illustrates a screen shot of an exemplary merchandise page 107 in the entertainer card system according to an embodiment of the invention. The merchandise page 107 includes a list of categories 108 of merchandise for selection by the user. The categories 108 may include, without limitation, men's apparel, women's apparel and merchandise. Upon selection of a category by the user, thumbnail pictures of one or more items 109 may be displayed. The user may select a thumbnail picture of a desired item to obtain additional details on the selected item. In this regard, selection of a thumbnail causes an item window 110 to be populated with information relating to the selected item. The item window 110 may include a larger picture of the item, as well as other pertinent information relating to the item. Further, the item window 110 may include a “BUY” button to allow the user to purchase the item. Selection of the “BUY” button may direct the user to an electronic commerce page, allowing the user to, for example, use a credit card to complete the purchase.

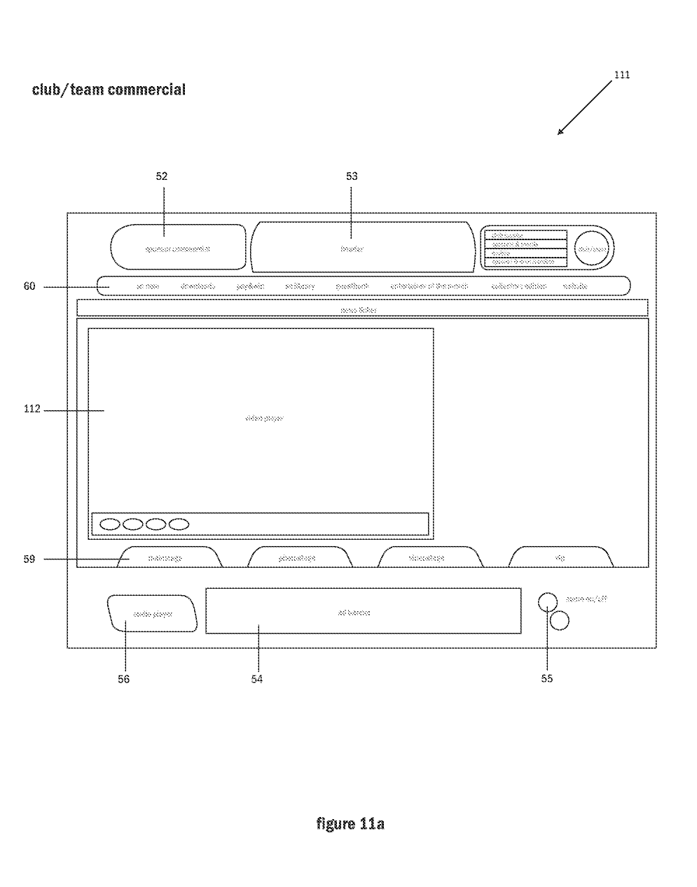

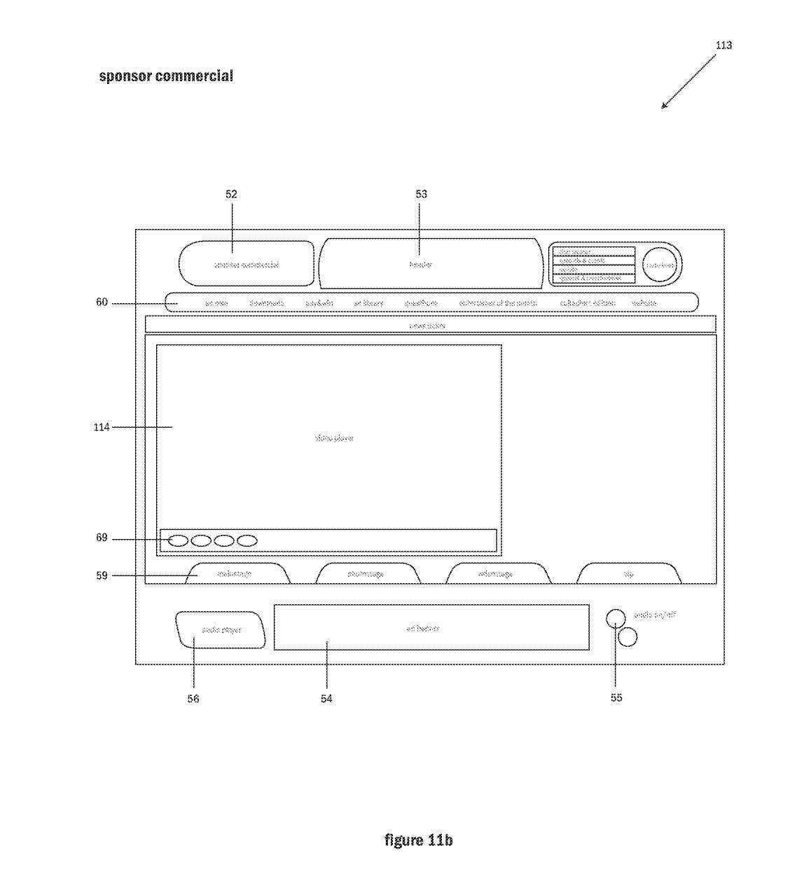

The entertainer card service may also include advertisement pages for various services, as exemplarily illustrated in FIGS. 11A and 11B. Referring first to FIG. 11A, a screen shot of an exemplary club commercial page is illustrated. The club commercial page 111 includes an advertisement for the club which may include, for example, a video portion 112 on which a video advertisement of the club may be played. Similarly, FIG. 11B illustrates a screen shot of an exemplary sponsor commercial page according to an embodiment of the present invention. The sponsor commercial page 113 may also include a video portion 114 for the playing of a video advertisement for a sponsor or a paying advertiser.

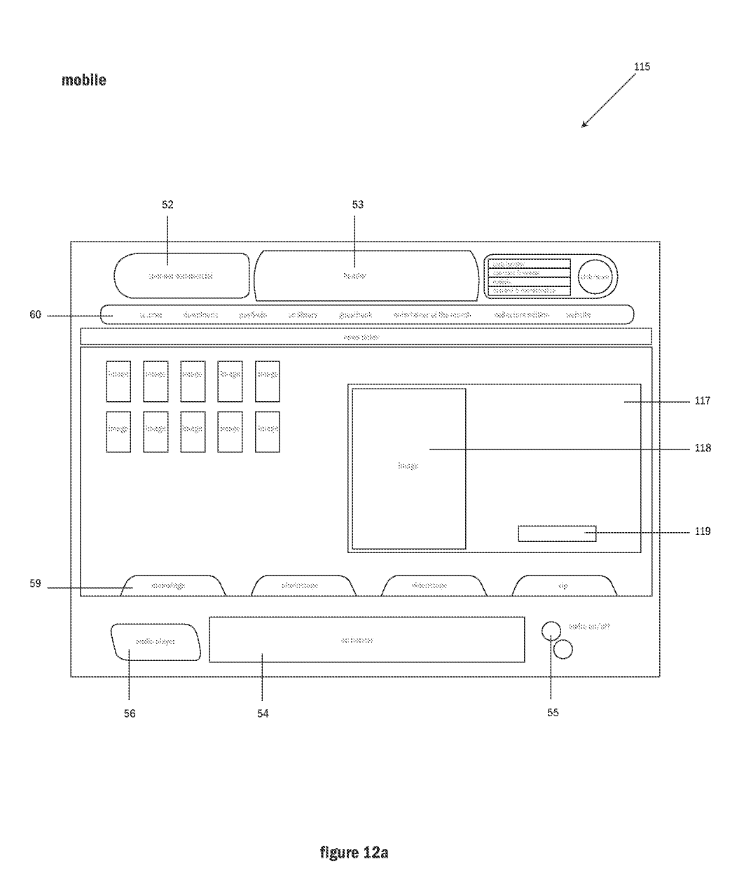

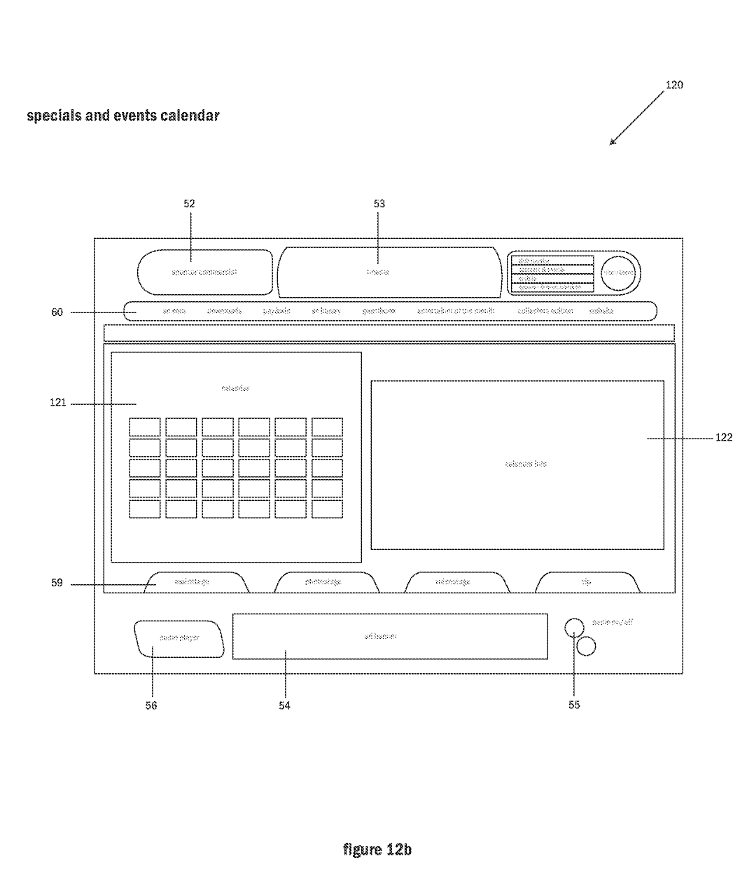

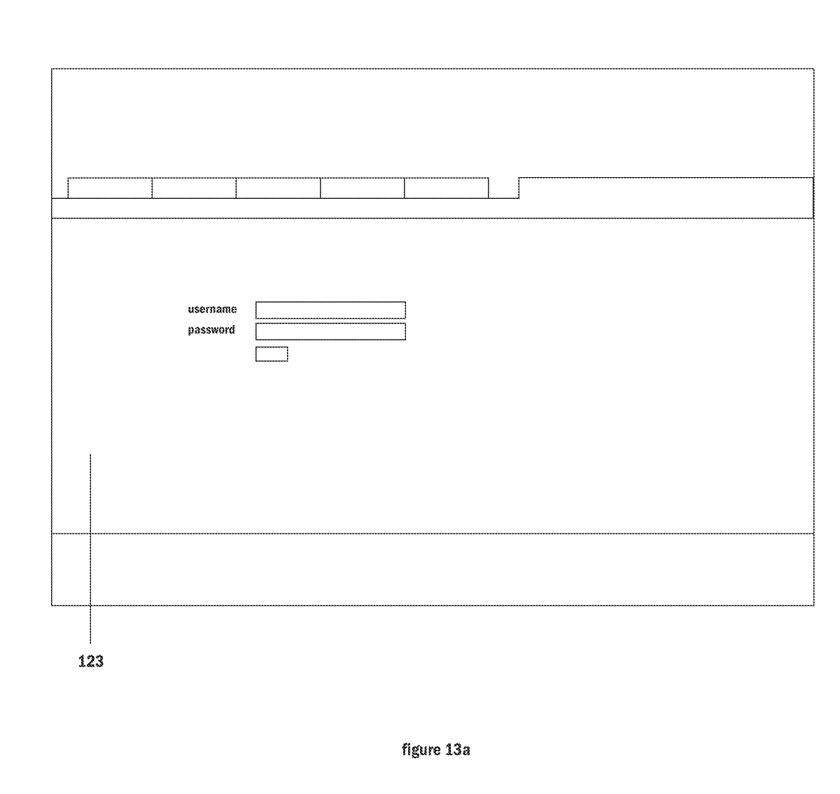

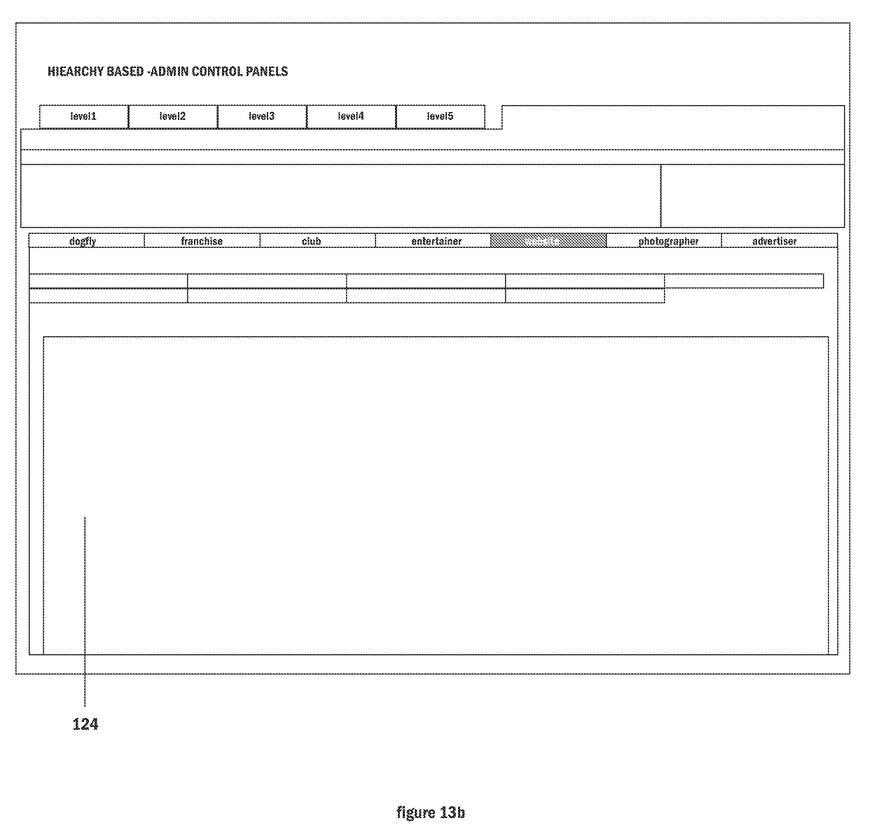

In one embodiment, as illustrated in FIG. 12A, the entertainer card service may provide access or features for mobile devices, such as mobile phones or personal digital assistants (PDA's), for example. As illustrated in FIG. 12A, a mobile edition of the entertainer card service may provide a page 115 from which a user may purchase downloads, such as background pictures or wallpapers for use on the mobile device. In this regard, the page 115 may include one or more thumbnails 116 of pictures available for download. Clicking on a thumbnail 116 may provide an enlarged preview 118 of the selected picture. Further, purchasing instructions 117 may be provided, along with a “BUY NOW” button to finalize the purchase of the download. In one embodiment, the cost of the purchase is charged to the user through the mobile service provider.

In another embodiment, the entertainer card system may include a calendar page to highlight specific events and specials associated with an entertainer, a club or a plurality of clubs or entertainers. One such calendar page 120 is illustrated in FIG. 12B. The calendar page 120 includes a calendar portion 121 which includes a calendar with particular events highlighted. The calendar portion 121 illustrated in FIG. 12B includes a monthly calendar. However, it will be apparent to those skilled in the art that other embodiments may include a weekly, quarterly, seasonal, yearly or other such calendar. In addition to the calendar portion 121, the calendar page 120 includes an entertainment portion 122 which may include a video stage for a selected entertainer, for example.

The content of the various pages of the entertainer card system may be controlled by one or more individuals or organizations. Control over the content may be organized in an hierarchical manner. For example, in one embodiment, a service provider may control the organization or templates for various pages for a plurality of clubs, while the club may be provided with the ability to organize content for the particular club. Further, one or more entertainer associated with the club may be provided with the ability to control content for the particular entertainer within the club's portion of the system.

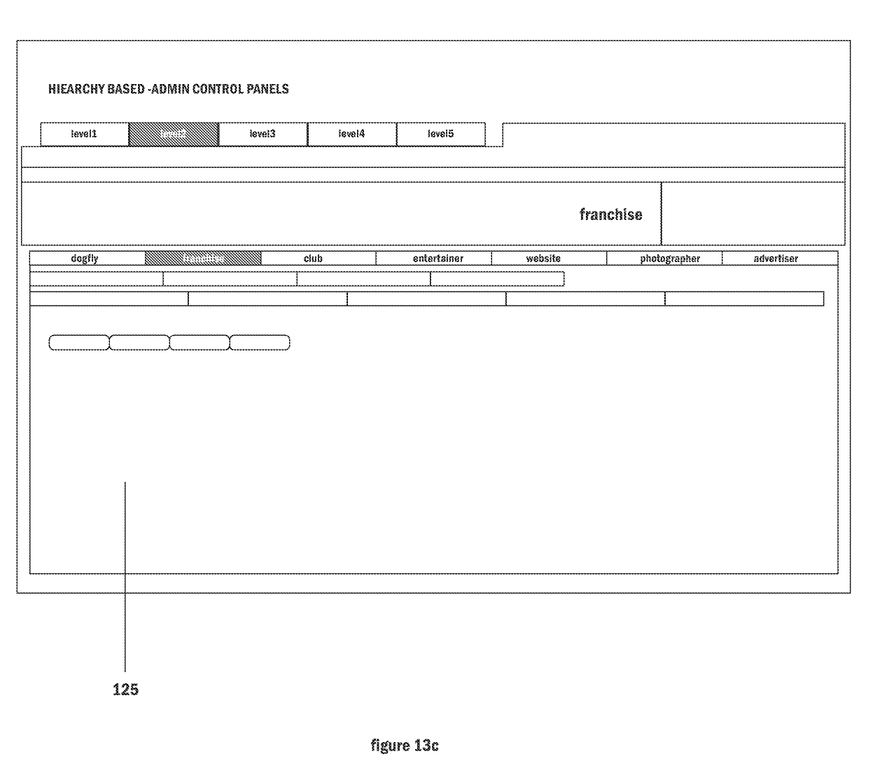

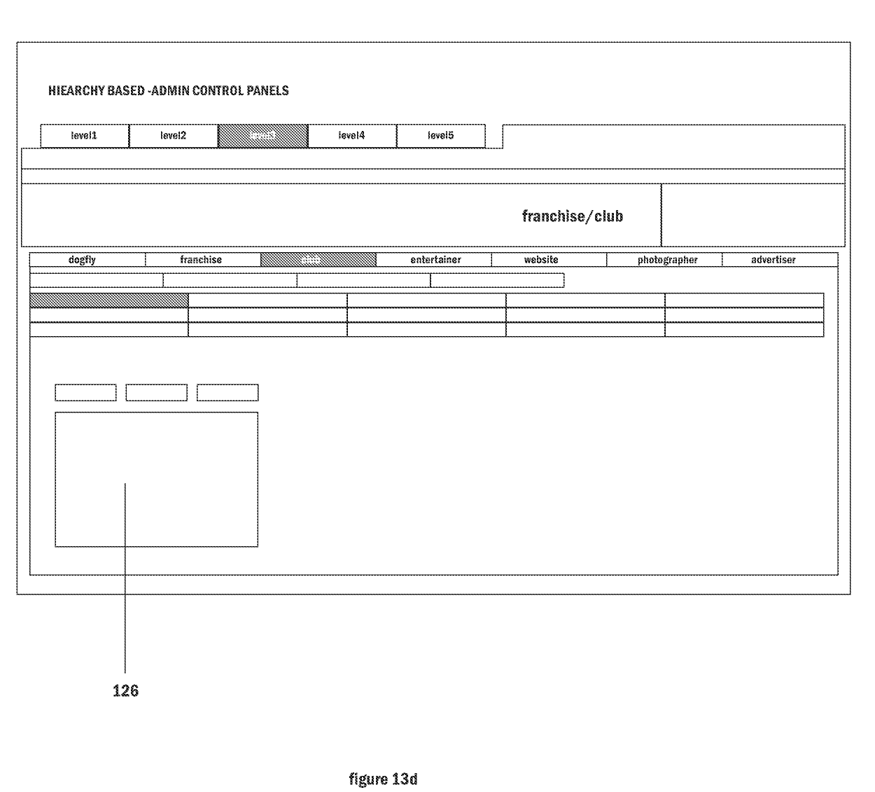

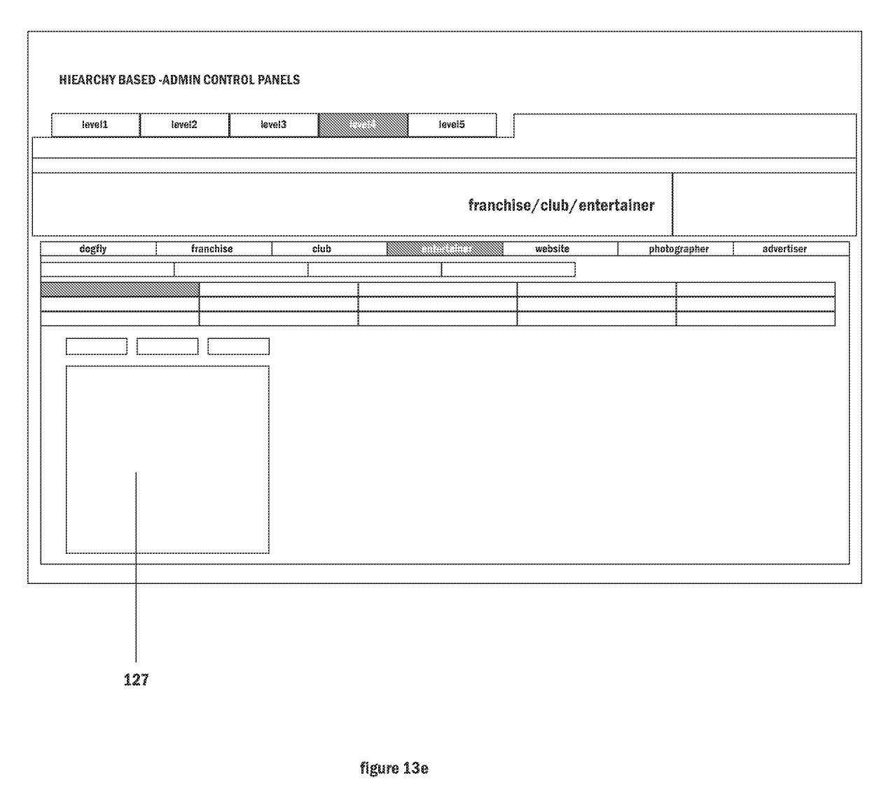

Control over the content may be provided through a back-end system which may be accessed by the various entities described above. FIGS. 13A-13E illustrate screen shots of exemplary pages for the back end of the entertainer card service. FIG. 13A illustrates a login page for authorized administrators. In this regard, the administrator may be an entertainer, a club manager or an administrator for the service provider. The username and password entered then determines the control rights provided to administrator logging in. Upon logging in, the administrator may be directed to a welcome page 124 for the entertainer card service, as illustrated in FIG. 13B.

Upon obtaining access to the backend, the administrator may be directed to a selection page 125, as illustrated in FIG. 13C. The selection page 125 may provide a list of all clubs, entertainers or other units for which the administrator is provided control. For example, a club administrator may be provided with control over a group of clubs owned by the same company. In this regard, the administrator may be provided with a listing of all such clubs. Upon selection of one of the clubs from the list, the administrator may be directed to a page for the selected club, as illustrated in FIG. 13D. At this page, the administrator is provided with options to view or change content of various aspects related to the club. For example, the administrator may view a list of the entertainers associated with the club.

The administrator may be able to select an individual entertainer to view and/or change content related to the individual entertainer. As illustrated in FIG. 13E, the administrator may view a page 127 for the selected entertainer. Buttons may be provided to allow the administrator to edit or remove some or all content related to the selected entertainer.

Similarly, each entertainer may be provided access to and control over content associated with the particular entertainer. In one embodiment, an entertainer may be associated with multiple clubs and may separately edit content for the entertainer at each club.

The above-described system may be used as a revenue-generating avenue. In this regard, revenue may be achieved through several channels. For example, the user may be charged for the purchase of the access card and access codes. Further, the user may be charged extra for access to certain features of the system. For example, in order to obtain access to the VIP stage of an entertainer, the user may be asked to upgrade his access to VIP status. Further revenue is generated through advertising and the purchase of prints and merchandise.

The revenue and profits may be divided among the various parties. For example, a portion of the all revenue may be directed to the service provider. Further, each entertainer may be rewarded a portion of the revenue generated through the sale of access codes corresponding to the entertainer, as well as revenue generated from the sale of prints for that entertainer. The club may be rewarded the remaining revenue.

While particular embodiments of the present invention have been disclosed, it is to be understood that various different modifications and combinations are possible and are contemplated within the true spirit and scope of the appended claims. There is no intention, therefore, of limitations to the exact abstract and disclosure herein presented.

What is claimed is:

1. An entertainer fan service method, comprising:
providing electronic access to a fan to a network service; and
providing features associated with one or more entertainers on the network service, the entertainer being associated with a club.

2. The method of claim 1, wherein providing electronic access comprises:
providing an access code to the fan, the access code corresponding to the club or one or more entertainers associated with the club.

3. The method of claim 1, wherein providing electronic access comprises:
providing an access card to the fan, the access card including a computer-readable medium having computer code to allow the fan to access the network service.

4. The method of claim 3, wherein the access card is provided to the fan when the fan visits the club.

5. The method of claim 3, wherein providing electronic access further comprises:
providing an access code to the fan, the access code corresponding to the club or one or more entertainers associated with the club.

6. The method of claim 1, wherein providing features comprises:
providing a photo stage including one or more photos of the entertainer in one or more categories.

7. The method of claim 1, wherein providing features comprises:
providing a video stage including one or more videos of the entertainer in one or more categories.

8. The method of claim 1, wherein providing features comprises:
providing one or more games featuring the entertainer and/or the club associated with the entertainer.

9. A computer-readable medium embodying a computer program configured to provide an entertainer fan service method, comprising:
providing electronic access to a fan to a network service; and
providing features associated with one or more entertainers on the network service, the entertainer being associated with a club.

10. The computer-readable medium of claim 9, wherein providing electronic access comprises:
providing an access code to the fan, the access code corresponding to the club or one or more entertainers associated with the club.

11. The computer-readable medium of claim 9, wherein providing features comprises:
providing a photo stage including one or more photos of the entertainer in one or more categories.

12. The computer-readable medium of claim 9, wherein providing features comprises:
providing a video stage including one or more videos of the entertainer in one or more categories.

13. The computer-readable medium of claim 9, wherein providing features comprises:
providing one or more games featuring the entertainer and/or the club associated with the entertainer.
